(19) United States
(12) Patent Application Publication
(10) Pub. No.: US 2007/0202483 A1
(43) Pub. Date: Aug. 30, 2007

(54) Method and system for performing best practice assessments of safety programs

(75) Inventors: Michael P. Castelli, Carmel, NY (US); Donald Whiteman, East Windsor, NJ (US); Scott Walker, Alpharetta, GA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/364,440

(22) Filed: Feb. 28, 2006

(51) Int. Cl. G09B 3/00

(52) U.S. Cl. 434/350

(57) ABSTRACT

A method and system for computer-assisted analyses of best practice safety assessment generates quantitative indicators of safety performance by using a questionnaire with questions in various sections directed to different areas of safety performance evaluation. Scores are given to the questions based on answers entered by an evaluator. The scores for the questions in each section are weighted and summed to provide a section score, and the section scores are weighted and summed to generate an overall score for the assessment. The scores for the individual sections and the overall score can be compared with scores of other clients and the average scores of the industry, and expected losses can be predicted based on the scores.

### FIELD OF THE INVENTION

The invention generally relates to evaluation of safety programs implemented at business facilities, and more particularly to a method and system for computer-assisted best practice assessments of safety programs.

### BACKGROUND OF THE INVENTION

Safety at a work place is a major issue for any business entity, especially when the business operation involves manual labors, use of chemicals, and/or operations of machinery such as vehicles and fork lifts. To protect the safety of workers, there are governmental rules, such as rules set by OSHA, to establish safety standards, and most well-managed businesses have a safety program in place to ensure compliance with such governmental rules and prevent work-related injuries. Having a good safety program in place not only helps workers avoid injuries but also directly benefits the business, because work-related accidents and injuries incur losses due to reduced productivity and interrupted workflow, and impose significant liabilities on the business entity. Thus, it is in the interest of a business entity to implement an effective safety program.

Having a well-implemented and functional safety program is, however, not an easy task. There are many different areas of safety operations that require continuous attention of the business management. For instance, besides having a program in place to enforce compliance with governmental rules, the management has to consider related issues such as allocation of resources or safety management, implementation of an accident investigation process, training of employees in safe work procedures, etc.

To ensure the existence of a functional safety program, it is common for a business entity to retain outside consultants to provide a professional assessment of the performance of its safety program implemented at a given facility. One type of assessment is called the “best practice assessment” because it is used to determine whether the business entity has taken proper measures to comply with general principles, guidelines, and suggestions that are considered the best practice for safety management. Traditionally, to perform a best practice assessment, a reviewer visits the client's facility to discuss with pertinent personnel and review documents to gather relevant information, and prepares a written report based on the information collected from the site survey to identify strengths and weaknesses of the safety program and areas that require improvements. There is typically no standardized algorithm for the reviewer to analyze the collected information to derive conclusions regarding the safety performance, and the report is typically written in narrative descriptions that conveys the conclusions of the safety evaluation via qualitative fashion. Even though such a report can be quite useful and informative for identifying problems, the evaluations therein often do not provide a clear picture of how well the safety program has been implemented and operated. This is complicated by the existence of many areas of the safety program that contribute in different degrees to the success or failure of the program. It is often hard to tell from reading such a report whether meaningful improvements have been made overall or in specific areas since the previous review. It is extremely difficult to compare, based on such report, the safety performance of one client with other clients or with the industry as a whole. Moreover, it is also difficult to derive from the report a useful prediction of the losses the client might expect in the future.

### SUMMARY OF THE INVENTION

In view of the foregoing, it is an object of the invention to provide a method and system for performing best practice assessments for safety programs that provides results in a way that facilitates clear and easy comparison with past performance of the client, with other clients, and with the industry as a whole.

In this regard, it is a related object of the invention to provide a method and system for best practice assessments that collects and analyzes data for safety performance evaluation in a quantitative manner to facilitate comparisons and statistical analyses.

It is a further related object of the invention to provide a standardized way for a reviewer to enter safety evaluation information that is easy and simple for the reviewer and that facilitates computational analyses of the evaluation information with the aid of a computer.

These objects and other related projects are achieved by the present invention, which provides a method and system for generating quantitative indicators, or scores, to indicate the performance of a safety program. In accordance with the invention, a best practice assessment is performed based on a questionnaire presented in an electronic form, such as by an application server over a network. The questionnaire includes multiple sections directed to different areas of safety review, and each section has a plurality of questions. A user, who is preferably a skilled consultant/assessor, is prompted to select from pre-defined possible answers presented in the questionnaire, based on the judgment of the user. Once the answered questionnaire is submitted, scores are given to the questions based on the respective answers selected by the user. The scores for the questions in each section are then weighted and summed to provide a score for the section. The scores for the sections are weighted and summed to provide an overall score. The section scores and the overall score of the safety review can be compared with scores from previous reviews, scores of other clients, and/or industry average scores. The scores can also be used in statistical analyses for identifying correlations between the scores and loss factors to enable predictions of future losses.

The advantages of the invention can be understood from the description of embodiments of the invention set forth below with reference to the drawings, in which:

### BRIEF DESCRIPTION OF THE DRAWING(S)

FIG. 1 is a schematic diagram showing an embodiment of a system in accordance with the invention for computer-assisted analyses for best practice assessments of safety programs;

FIG. 2 shows a user interface page provided by an application server for presenting a questionnaire for a user to enter answers regarding the safety program of a client;

FIG. 3 shows a schematic diagram illustrating a process of generating quantitative safety performance scores from answers entered in response to the questionnaire;

FIG. 4 is a chart showing an example of safety performance scores for a client;

FIG. 5 is a chart showing performance scores for multiple clients and industry average plotted together for comparison; and

FIG. 6 is a chart showing a statistical correlation between the overall score of best practice assessment and a loss factor.

### DETAILED DESCRIPTION OF THE INVENTION

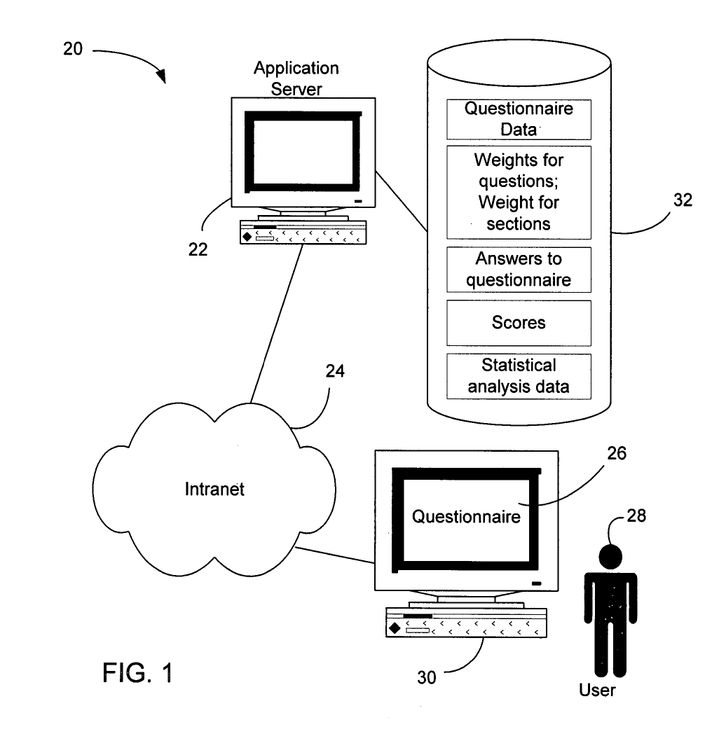

FIG. 1 shows an embodiment of a system 20 for performing quantitative analyses for best practice assessments of safety programs in accordance with the invention. The system has an application server 22 that provides computer-assisted data collection and data analyses to generate quantitative indicators, or scores, for indicating the performance of a safety program in various areas. The application server 22 runs on a machine that resides on a computer network 24. The application server 22 is preferably implemented as a web server using well-known programming tools for web servers. The placement of the application server 22 on the network 24 allows multiple users to access the application server through the network 24. In the illustrated example, a user 28 carrying out the best practice assessment of a safety program implemented at a client facility enters safety evaluation information, which is used by the application server 22 as input for generating a best practice assessment report. To that end, the user 28 has a computer 30 that is linked to the network 24 to communicate with the application server 22. In a preferred embodiment, the network 24 is the intranet of the service provider that provides the service of best practice assessments. Alternatively, the network 24 may be a public network such as the Internet. In that case, security measures on different levels, such as password protection, encryption, and point-to-point tunneling, etc., are preferably implemented to prevent eavesdropping of communications, tampering of data, and theft of information.

In accordance with a feature of the embodiment, the application server 22 is programmed to interact with the user 28 to collect relevant safety assessment information for generating the assessment report. The user's computer 30 is used by the application server 22 as a user interface for prompting the user 28 to enter evaluation data, and the data entered by the user 28 are transmitted to the application server 22 via the network 24. In this case, the user 28 may be a representative of the service provider that provides the best practice assessment service. Once the user computer 30 is connected to the application server 22, the server authenticates the user, e.g., by means of user ID and password, to ensure that the user is authorized to access the server. Thereafter, the application server 22 provides user interface screens on the user's computer 30 to present a questionnaire 26 with multiple questions for the user to answer. The questionnaire may also include data fields for the user to enter relevant information and comments. In this regard, the application server 22 may be configured as a web server that presents HTML pages containing the questions to be answered and fields through which the user can enter answers and comments. Alternatively, the questionnaire may be presented as a spread sheet, with fields to be filled by the user.

Alternatively, the user computer 30 may be used to collect information when it is not connected to the network 24. This may occur, for instance, when the user is in the field to perform a site survey and is not able to connect to the network 24. In this case, the user computer 30 is loaded with a program that presents the questionnaire for interacting with the user to collect the evaluation data. After the user returns to the office, the user computer 30 is connected to the network 24, and the information collected in the field is uploaded to the application server 22.

The application server 22 includes a database 32 for storing data for the questionnaire, and evaluation data provided by users for best practice assessment studies, and data used for analyzing the user data. The results of the analyses are also archived in the database 32. The archived data can be used to generate reports and to perform statistical analyses, and the results of the statistical analyses are also stored in the database 32.

In accordance with a feature of the invention, the questionnaire 26 presented by the application server to the user is designed to facilitate generation of quantitative results that can be used in performance comparisons and statistical analyses. The questionnaire 26 has multiple sections directed to different areas of the safety performance assessment. Each section contains a number of questions pertaining to the particular area of that section. The numbers of questions in the sections would depend on the design of the questionnaire and do not have to be the same. For each question, the user is asked to choose from a plurality of possible answers, and a score is assigned to that question based on the answer selected by the user.

By way of example, a question in a section in the questionnaire directed to “Management Responsibility” may be as follows:

Q 1.1: Does the Management support and direct the safety process?

To answer this question, the user can select from one of the following possible answers, with the corresponding scores:

NA—Not applicable.

01—Never

02—Rarely—not as a routine practice

03—Sometimes—to a moderate extent

04—A routine practice—only minor improvements are needed

05—Always as a “Best Practice”

The user is required to select from this list an answer that best describes his assessment of the safety program in the particular aspect identified by the question. If the question does not apply to the operations or injury exposures of the particular client, the user should select the answer “NA.” If “NA” is selected, the question will not be taken into consideration for calculating the score for the particular section of the questionnaire or the overall score for the safety performance, as will be described in greater detail below.

To provide uniformity and simplicity of the answer selection by the user, the same set of possible answers, such as the set described above, may be presented for each of the scored questions in the questionnaire. This is, however, not a required feature of the invention, and each question may be given a different set of possible answers, as long as a score can be properly assigned to the answers, and such scores are amenable to weighted summation to provide sectional scores and an overall score that provide useful indications of the performance of safety programs.

To further describe the invention by way of example, in one implementation, the questionnaire has ten (10) different scored sections, with each section focusing on a particular area of the safety program implemented by the client. The sections of the questionnaire, and the questions in the respective sections, are provided below.

Section 0: Facility Profile
Facility Address?
SIC/NAIC Number and Description?
Number of Employees?
Published BLS Rate—Total Recordable Case Rate?
Published BLS Rate—Lost and Restricted Workday Case Rate?
Loss Experience?
Total Recordable Cases Rate?
Lost and Restricted Workday Rate?
Claim Frequency?
Claim Severity?

Section 1: Management Responsibility
Does management Support and direct the safety process?
Has management established safety performance goals?
Do supervisors have responsibilities for safety?
Is there a safety budget for capital expenditures for safety-related repairs and modifications?
Is there an executive safety committee?

Section 2: Accident Investigation
Has an accident investigation process been implemented?
Have individuals conducting accident investigations been trained in the techniques of effective accident investigations?
Does a process exist to communicate and review the findings of accident investigations for resolution of the recommended corrective actions?
Are accident investigation reports maintained (including “close call” investigations)?
Are written records of corrective actions/follow-ups for accident investigations maintained?

Section 3: Hazard Assessment
Is there a written safety self-inspection program?
Are self-inspections completed by a trained person?
Is there a process to correct conditions or behaviors identified by the inspection?
Are job safety analyses (JSA) completed for major and high hazard work tasks?
Are Job Hazard Assessments documented and updated accordingly as process or job changes may occur?

Section 4: Training
Do new employees receive safety orientation prior to job assignment?
Is there allocation of time for training in addition to orientation training?
Are supervisors trained in their safety responsibilities including departmental inspections, employee observations and accident investigations?
Are safety training records for each employee maintained?

Section 5: Employment Practice
Are employees selection procedure developed and applied to the hiring process?
Is there a safety incentive program?
Is there an employee recognition program for safety performance?
Are there disciplinary procedures for violation of rules?

Section 6: Claim Management
Is there a procedure in place for providing medical attention to injured employees?
Have designated individuals been assigned to organize, coordinate, and direct the claim management function?
Is a formal first aid program implemented?
Is an early return to work (“ERTW”) program in place and documented?
Are claim administration files maintained on each injured employee?
Are OSHA 300 logs maintained, signed, and posted when and where required?
Are claims and accident information used to analyze frequency and severity trends?

Section 7: Communications
Is there a safety committee?
Do supervisors conduct scheduled safety meetings with employees?
Are loss trends and claims/accident costs communicated to employees, such as “Lessons Learned”?
Is there a method for employees to communicate safety-related issued or concerns and report to management?

Section 8: Security and Emergency Response
Are policies and procedures in place response to an emergency incident?
Are policies and procedures in place to prevent and respond to workplace violence?

Section 9: Leading Injury Control Measures
Has a program been implemented with the following core elements to address related to manual material handling, repetitive motion, and cumulative trauma exposure? {List of core elements}
Is a fall prevention program in place with the following core elements? {List of core elements}
Is a vehicle safety program implemented with the following core elements? {List of core elements}

Section 10: Compliance
Is a Machine and Equipment Control Program in place with the following core elements? {List of core elements}
Is a Hazard Communication Program implemented to include the following core elements? {List of core elements}
Has a Respiratory Protection Program been implemented that includes the following core elements? {List of core elements}
Is a Personal Protective Equipment Program in place that includes the following core elements? {List of core elements}
Is a Lockout/Tagout Program implemented with the following core elements?
Has a Hearing Conservation Program been implemented that includes the following core elements? {List of core elements}
Is a Bloodborne Pathogens Program in place that includes the following core elements? {List of core elements}
Has a Confined Space Entry Program been implemented with the following core elements? {List of core elements}
Has a forklift Safety Program been implemented that includes the following core elements? {List of core elements}
Has a Preventative Maintenance Program been implemented that includes the following core elements? {List of core elements}
Has a Contractor Control Program been implemented that includes the following core element? {List of core elements}

In this example, Section 0 is directed to the facility profile, and the user is asked to enter information regarding the facility, such as the facility address, number of employees, etc. Questions in this section are not given scores. In contrast, Sections 1-10 require the user to select answers based on the user's assessment of the best practice compliance of the safety program, and each answer is assigned a score. It will be appreciated that these sections and questions are provided here only as an example of a questionnaire designed for use for best practice assessment in accordance with the invention, and are not intended to limit the applications of the invention. The sections and questions in the questionnaire can be designed according to the particular information needs for evaluating particular clients, particular groups of clients, or particular industries, and may be refined from time to time based on feedback obtained from prior assessments.

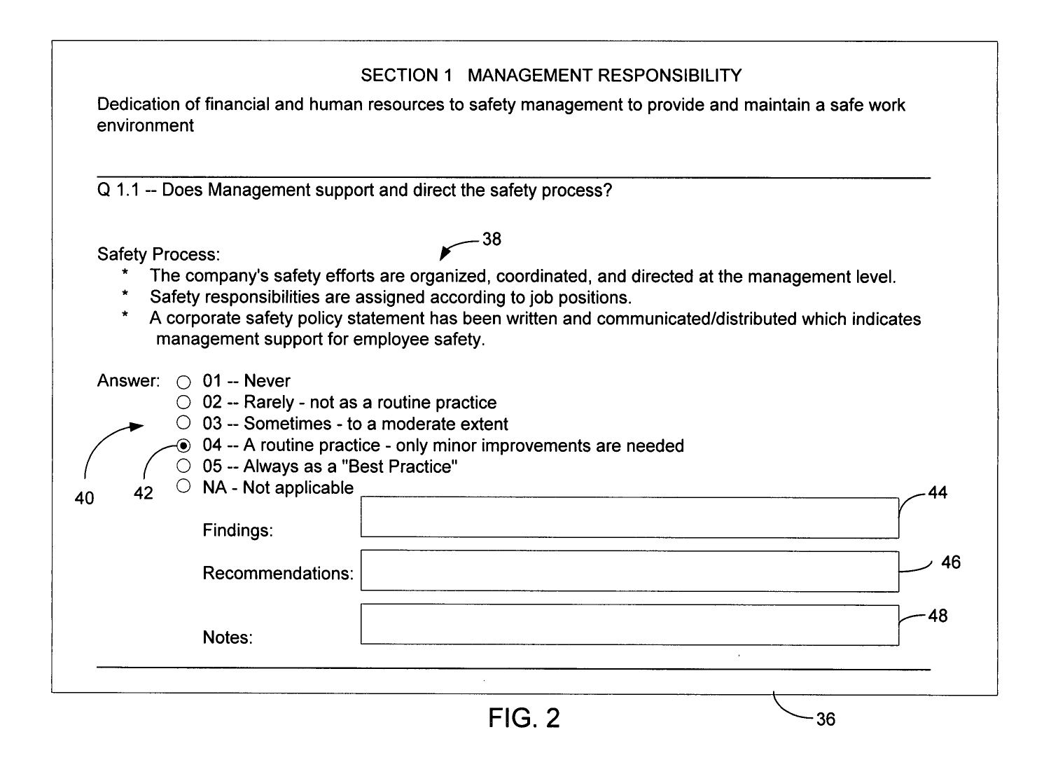

As described above, the questionnaire 26 is presented by the application server 22 in an electronic form to the user 28. FIG. 2 shows an example of a user interface screen 36 showing a portion of the questionnaire. In this example, the screen displays the question “Does Management support and direct the safety process?” In addition to the question, the questionnaire may also include additional information for helping the user understand the question and providing context for the question. For instance, for the particular question in FIG. 2, the questionnaire includes a description 38 that defines the “best practice” for “safety process” as follows:

Safety Process:

The company's safety efforts are organized, coordinated, and directed at the management level.
Safety responsibilities are assigned according to job positions.
A corporate safety policy statement has been written and communicated/distributed which indicates management support for employee safety.
   The program also allows the inclusion of specific references. For example, the web pages presenting the questionnaire may include a digital photograph illustrating the best practice, a specific requirement from the client's safety program, or a link to a regulation, to assist the user in answering the questions.

In this example, the text 38 identifies the actions expected to be taken as best practice by the management to support and direct the safety program. The user can assess how well the client has complied with the best practice, and select the appropriate answer from the list 40 of possible answers by checking the radio button 42 next to the proper answer. Depending on the nature of the question, such description 38 of best practice actions may be useful but is not required for every question in the questionnaire.

Besides selecting an answer from one of the provided answers 40, the user can also enter comments related to the particular question. For instance, in the user interface in FIG. 2, the questionnaire includes a Findings field 44, Recommendation fields 46, and a Note field 48, for the user to enter text regarding finds, recommendations, and notes.

After answering all the questions in the questionnaire and checking the answers, the user hits the “Complete” button. The user is then asked by the program to verify the questionnaire and provide the date. The system may also be set up such that the answered questionnaire is forwarded to a second assessor to verify the assessment. The user may also be required to provide a signature or other type of authentication information, such as an electronic certificate, for ensuring accountability before the questionnaire can be submitted. In another scenario, the questionnaire may be loaded onto the user's computer 30 such that the user can answer the questionnaire while in the field without having to be connected to the network 24 on which the application server 22 resides. In that case, when the user returns from the field trip and connects the computer 30 to the network, the answered questionnaire can be uploaded to the application server 22 for analysis.

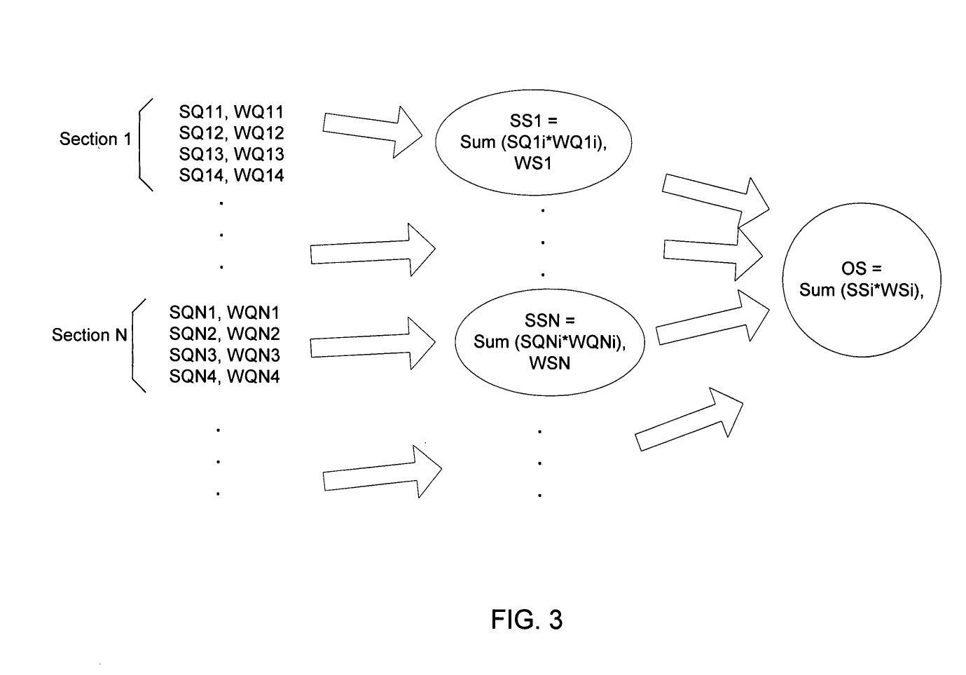

In accordance with a feature of the invention, the application server 22 calculates scores as quantitative indicators to enable assessments of how well the client has performed in implementing and operating its safety program. As shown in FIG. 3, for each question in the submitted questionnaire that has selectable answers with associated scores, the application server 22 gives it a score according to the answer selected by the user. The score SQ_{Ni} for each question Q_{Ni} in a given section N is then multiplied by a pre-assigned weight WQ_{Ni}, and the weighted scores SQ_{Ni}*WQ_{Ni} for the questions in each section are then summed to provide a score SS_{N} for that section. Even though each question is directed to a particular aspect that is import to the performance of the safety program, the different aspects of the questions in a section contribute in different degrees to the safety performance in the area associated with that section, and their respective degrees of contribution are reflected by the weights assigned to them. As mentioned above, each section in the questionnaire is directed to a particular aspect or area regarding the best practice assessment. Thus, the score for a given section provides a quantitative indicator of how well the client performs in that particular area. The section score SS_{N} is preferably normalized such that the maximum score for each section is 100%.

To generate a quantitative indicator of the client's overall safety performance, the score SS_{N} of each section is multiplied by a pre-assigned weight WS_{N}, and the weighted sectional scores SS_{N}*WS_{N} are summed to generate an overall score OS. The weights WS_{N} for the sections indicate the relative contributions of the safety areas of the sections to the overall performance of the safety program. This overall score OS provides a way for the reviewer to quantitatively indicate the overall performance of the client's safety program. The overall score OS is preferably normalized so the maximum overall score is 100%.

The weights WQ_{Ni} assigned to individual questions and the weights WS_{N} to different sections of the questionnaire are pre-determined. They may be set, for example, by experts and experienced reviewers, with the aid of statistical analyses of relevant data, to adequately reflect the significance of the particular questions to a given section, and the significance of a given section to the overall assessment of the safety program. To facilitate the computer-assisted analyses, the pre-assigned weights for the questions and sections are stored in the database 32, and can be retrieved by the application server for analyzing an answered questionnaire submitted by a user.

One significant advantage of having the overall score and the section scores is that these scores provide quantitative indications of how well the safety program performs. In particular, the scores enables comparisons of the current safety program of a client with a previous state of the safety program of the same client, with the safety programs of other clients, and with the average safety performance of the industry. Comparisons may even be made across industries. To that end, the answered questionnaires submitted by users for different clients and the section scores and overall scores calculated from the answered questionnaires are stored in the database 32, so that they can be retrieved for statistical analyses and comparisons.

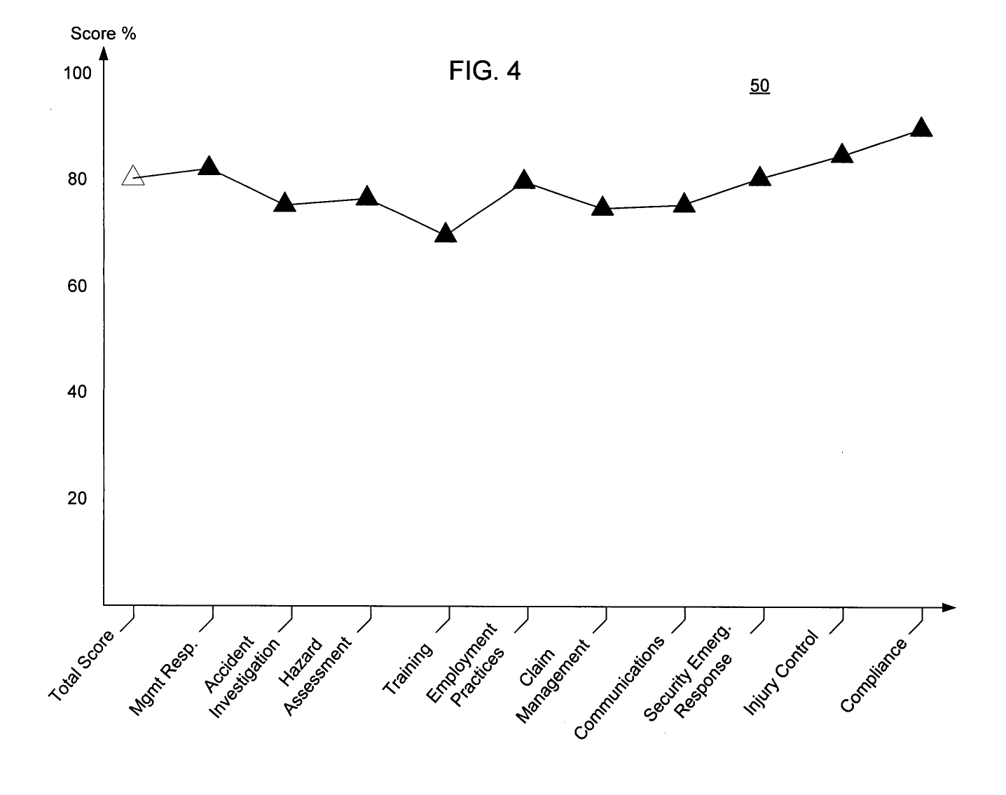

By way of example, FIG. 4 shows the scores for the ten scored sections of the questionnaire as described above from a best practice assessment study for one client. The scores are plotted in a chart 50, with the vertical axis showing the normalized scores (100% maximum). Using this chart, the reviewer can give the client a clear picture of how well the client's safety program has performed in the various areas of safety program. This chart is especially useful in identifying areas in which the client has done well, and those areas that require improvements.

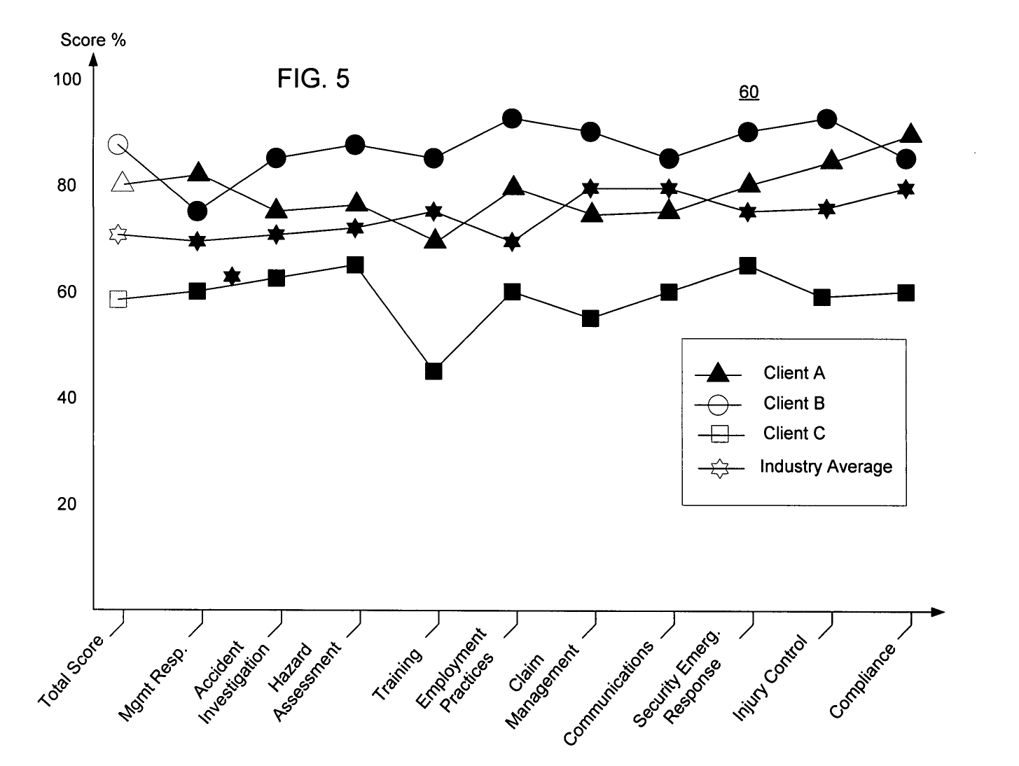

FIG. 5 shows another comparison of performance scores. The section scores for different clients, as well as the average scores for the industry, are plotted in the same chart 60. This comparison shows, for each of the sections in the questionnaire, how the safety program of a given client has performed vis-á-vis other clients and the industry average. Such a comparison not only is useful to show the relative strengths and weaknesses of a given client in different safety areas, but is also useful to show how the clients as a group have performed. With the clients in the group belonging to a particular industry, this type of comparison may be useful for identifying particular issues pertaining to the industry. A comparison of averages scores for one industry with the averages scores of another industry is also useful for identifying industry-dependent differences.

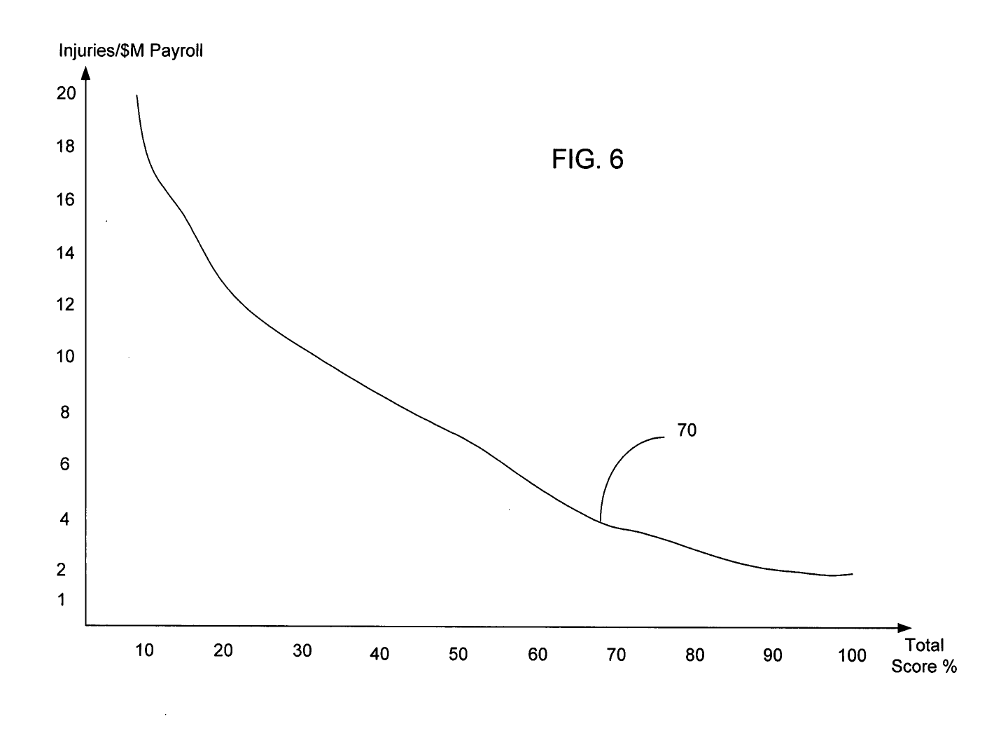

Another usage of the scores of the best practice assessments that provides useful information for decision making and other purposes is to correlate the performance scores to loss factors. A loss factor may be, for example, the number of reported injuries per million dollars of payroll, or the number of claims per 100 employees per year, etc. By way of example, FIG. 6 shows a correlation curve 70 between the overall score and the number of reported injuries per million dollars of payroll. This curve may be generated via statistical regression analyses using the overall scores from best practice assessment reports generated previously for various clients in the industry and the loss factor data collected from the clients. Using this correlation curve, the reviewer can predict, based on the overall score of the current BPA review, the number of claims per million dollars of payroll that the client may expect. Similar correlation curves can also be generated to indicate the correlations between the section scores and various selected loss factors.

In view of the many possible embodiments to which the principles of this invention may be applied, it should be recognized that the embodiment described herein with respect to the drawing Figures is meant to be illustrative only and should not be taken as limiting the scope of invention. Those of skill in the art will recognize that the elements of the illustrated embodiments can be modified in arrangement and detail without departing from the spirit of the invention. Therefore, the invention as described herein contemplates all such embodiments as may come within the scope of the following claims and equivalents thereof.

1. A method of generating quantitative indicators for a performance assessment of a safety program, comprising:
presenting through an electronic user interface a questionnaire having a plurality of sections each having a plurality of questions, each section being directed to one area of safety performance assessment;
receiving, through the electronic user interface, answers for respective questions in the questionnaire;
assigning scores to the questions in the questionnaire based on received answers for the respective questions;
applying weights to the scores of the questions;
for each section, summing weighted scores for questions in said each section to provide a section score;
applying weights to the section scores; and
summing the weighted section scores to provide an overall score.

2. A method as in claim 1, wherein the step of receiving includes presenting through the user interface a set of possible answers for a question for selection by a user, and wherein each one of said plurality of possible answers has a pre-defined score associated therewith.

3. A method as in claim 2, wherein the step of receiving includes presenting a common set of multiple possible answers for each of a plurality of questions in the questionnaire.

4. A method as in claim 1, wherein the steps of applying weights to questions and applying weights to sections include retrieving pre-defined weight data for respective questions and sections from a database.

5. A method as in claim 4, wherein the step of summing weighted scores for questions includes normalizing the section score to have a maximum value of 100%.

6. A method as in claim 5, wherein the step of summing the weighted section scores includes normalizing the overall score to have a maximum value of 100%.

7. A method as claim 5, further including the step of presenting the section scores in a chart.

8. A method as in claim 7, wherein the chart includes section scores derived from other performance assessments.

9. A method as in claim 4, further including the step of performing a statistical analysis to identify a correlation between the overall score and a loss factor.

10. A method as in claim 1, wherein the step of presenting the questionnaire includes transmitting the questionnaire via a network to a user computer.

11. A method as in claim 1, wherein the step of presenting the questionnaire includes presenting data entry fields for receiving data other than the answers for the respective questions.

12. A system for generating quantitative indicators for an assessment of performance of a safety program, comprising:
an application server residing on a network; and
a database storing pre-defined weights for respective questions and sections of the questionnaire;
the application server being programmed to present a questionnaire via an electronic user interface, receive through an electronic user interface answers for respective questions in the questionnaire, assign scores to the questions in the questionnaire based on received answers for the respective questions, apply weights to the scores of the questions, sum weighted scores for questions in each section to provide a section score for said each section, apply weights to the section scores, and sum the weighted section scores to provide an overall score.

13. A system as in claim 12, wherein the application server is programmed to present through the user interface a set of possible answers for a question for selection by a user, and wherein each of said plurality of possible answers has a pre-defined score associated therewith.

14. A system as in claim 13, wherein application server is programmed to present a common set of possible answers for each of a plurality of questions in the questionnaire.

15. A system as in claim 12, wherein the application server is programmed to normalize the section score to have a maximum value of 100%.

16. A system as in claim 15, wherein the application server is programmed to normalize the overall score to have a maximum value of 100%.

17. A system as in claim 16, wherein the application server is programmed to present the section scores in a chart.

18. A system as in claim 16, wherein the application server is programmed to perform a statistical analysis to identify a correlation between the overall score and a loss factor.

19. A system as in claim 12, wherein the database stores answers to the questionnaire for a plurality of performance assessments.

20. A system as in claim 12, wherein the application server is programmed to transmit the questionnaire via the network to a user computer.
